(19) United States
(12) Patent Application Publication
(10) Pub. No.: US 2011/0305534 A1
(43) Pub. Date: Dec. 15, 2011

(54) Cutting Tool for Drilling and Turning

(75) Inventors: Hong Sik Park, Daegu (KR); Sung Hyup Park, Daegu (KR)

(73) Assignee: TaeguTec, Ltd., Dalsung-gun, Daegu (KR)

(21) Appl. No.: 13/148,446

(22) PCT Filed: Sep. 10, 2009
(86) PCT No.: PCT/KR2009/005136

§ 371 Date: Aug. 8, 2011

(30) Foreign Application Priority Data
Feb. 9, 2009 (KR) 10-2009-0010265

(51) Int. Cl. B23B 27/16

(52) U.S. Cl. 407/100; 407/113

(57) ABSTRACT

The present invention relates to a cutting tool capable of both drilling and internal/external turning. The cutting tool comprises a generally triangular-shaped cutting insert and a tool holder. On each side, the triangular-shaped cutting insert forms a major cutting edge and a minor cutting edge, which is shorter than said major cutting edge. Two adjacent major cutting edges form an angle of 60° therebetween, while adjacent major and minor cutting edges intersecting at a corner of the triangular shape of the cutting insert form an angle of 80 to 89° therebetween. The cutting insert is mounted in a pocket so that one of the major cutting edges of the cutting insert is projected in an axially forward direction of the tool holder, while the minor cutting edge on the side adjacent to the projected major cutting edge is projected in a radially outward direction of the tool holder.

### TECHNICAL FIELD

The present invention generally relates to a cutting tool, and more particularly to a cutting tool capable of both drilling and internal/external turning.

### BACKGROUND ART

A cutting tool, which can perform both drilling and internal/external turning, is advantageous since it is not necessary to change tools according to desired operations. Thus, the machining time can be reduced and the productivity can be improved.

U.S. Pat. No. 6,877,935 discloses the above-described cutting tool, which can perform both drilling and turning. Referring to FIG. 8, the cutting tool of U.S. Pat. No. 6,877,935 comprises a hexagonal cutting insert (7) forming six cutting edges (71) of the same length. The largest width (B) of the cutting insert (7) is approximately the same as the diameter (D) of a tool holder so that the cutting edge (71) can extend over the entire front side of the tool holder (6).

However, in the cutting tool of U.S. Pat. No. 6,877,935, since the width (B) of the cutting insert (7) is approximately the same as the diameter (D) of the tool holder, a pocket receiving the cutting insert (7) occupies a large area in the front end of the tool holder (6). Thus, a reinforcement portion (61) cannot be adequately secured. As such, the rigidity of the tool holder (6) is decreased, which causes the tool holder (6) to twist. This generates serious vibrations during machining, which in turn significantly reduces the cutting efficiency.

Cutting chips separated from a workpiece during a drilling operation are transferred along the surface of the cutting insert (7) and become broken when they collide with a wall (62) of the tool holder (6). They are then discharged into a chip discharge groove (63) of the tool holder (6). In the cutting tool of U.S. Pat. No. 6,877,935, the wall (62) of the tool holder is disposed at the very side of the tool holder since the cutting tool has the large cutting insert (7). Thus, the breakage of the chips can be likely delayed and long chips may be produced. The long chips can interfere with the feed of cutting oil, damage the workpiece and the insert tip, and cause poor chip discharge performance due to tangled chips.

Further, as shown in FIG. 9 depicting a side surface of the cutting insert (7), a rake angle of the cutting edge (71) is changed from positive to negative. This causes problems since it increases the cutting resistance and generates vibrations.

As another tool for drilling and turning, a cutting tool having a generally rectangular cutting insert has been suggested. Such a cutting insert comprises two cutting edges for cutting (drilling) in an axial direction of the tool holder and two cutting edges for cutting (turning) in a perpendicular direction thereto. The cutting insert is mounted so as to be biased from the center of the tool holder. In such a cutting tool, the tool holder is likely to be twisted since the cutting resistance during a cutting operation is transferred asymmetrically with respect to the center of the tool holder. Thus, it is necessary to mount the cutting insert to the tool holder more securely and to enhance the rigidity of the tool holder. Further, this cutting tool has a problem since a portion of the front end of the tool holder, at which the cutting insert is not mounted, is damaged by the cutting chips generated during the cutting operation. This reduces the life of the tool holder.

### DISCLOSURE OF INVENTION

### Technical Problem

The object of the present invention is to solve the above-described problems of the conventional cutting tools by maintaining the rigidity of a tool holder so that vibrations can be reduced. The present invention also seeks to facilitate the chip discharge and reduce the cutting resistance. Further, the present invention also seeks to provide a cutting tool with an extended lifetime by protecting the tool holder.

### Technical Solution

To achieve the objects mentioned above, a cutting tool for drilling and turning of the present invention comprises a generally triangular cutting insert, a tool holder having a pocket that receives the cutting insert and a chip discharge groove that facilitates the discharge of chips. On each side, the cutting insert forms a major cutting edge and a minor cutting edge, which is shorter than said major cutting edge, wherein two adjacent major cutting edges form an angle of 60° therebetween, and wherein adjacent major and minor cutting edges intersecting at a corner of the triangular shape of the cutting insert form an angle of 80 to 89° therebetween. The cutting insert is mounted in the pocket so that one of the major cutting edges is projected in an axially forward direction of the tool holder, while the minor cutting edge on the side adjacent to the projected major cutting edge is projected in a radially outward direction.

In accordance with one embodiment of the present invention, a length of one side of said cutting insert is 0.65 to 0.85 times of a diameter of the tool holder.

As the distance from the corner of the cutting insert increases, the height of the major cutting edge from the bottom surface of the cutting insert decreases until the lowest point beyond the center of the tool holder. It then increases again as it approaches the minor cutting edge. At this time, the portion of said major cutting edge, in which the height of the major cutting edge increases again, is slanted by an angle of 20 to 70°, preferably 45°, with respect to the bottom surface of the cutting insert. This is so that the cutting chips transferred from the corner of the cutting insert collide with the portion.

Further, the tool holder is provided with a chip guide surface upwardly extending to an outer peripheral surface of the tool holder. This is so that the cutting chips generated from the major cutting edge are guided backwardly from the front end of the chip discharge groove.

### ADVANTAGEOUS EFFECTS

According to the present invention, the cutting insert is securely supported in the tool holder. The rigidity of the tool holder is enhanced so that vibrations during cutting operations are reduced. In addition, chip discharge is facilitated, cutting resistance is diminished and lifetime of the tool holder is extended by the edge shape of the cutting insert and chip guide surface of the cutting tool of the present invention.

### BRIEF DESCRIPTION OF DRAWINGS

FIG. 1 shows a perspective view of a cutting tool according to the present invention.

FIG. 2 shows a perspective view of a cutting insert according to the present invention.

FIG. 3 shows a top surface and a lateral surface of the cutting insert according to the present invention.

FIG. 4 shows an orthographic view of the cutting tool according to the present invention.

FIGS. 5 to 7 show operations which can be performed by the cutting tool according to the present invention.

FIG. 8 shows a cutting tool according to the prior art disclosed in U.S. Pat. No. 6,877,935.

FIG. 9 shows a cutting insert according to the prior art disclosed in U.S. Pat. No. 6,877,935.

### MODE FOR THE INVENTION

The preferred embodiment of the present invention will be specifically described with reference to the drawings.

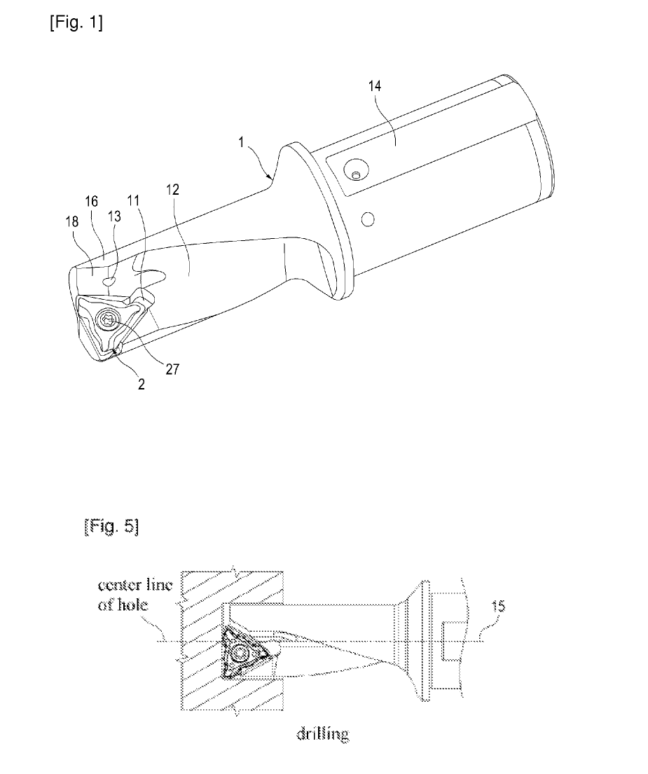

FIG. 1 shows a perspective view of a cutting tool according to the present invention, which is capable of drilling and turning. The cutting tool comprises a tool holder (1) and a cutting insert (2). The tool holder (1) is generally cylindrical and comprises a pocket (11) that receives the cutting insert (2), a chip discharge groove (12) that facilitates the discharge of chips, a cutting oil supply pipe (13) and a shank (14). A chip guide surface (18) is formed at the front end portion of the chip discharge groove (12) and extends to the peripheral surface of the tool holder (1). The chip guide surface (18) guides cutting chips generated from the cutting insert (2) at the front end portion of the chip discharge groove backwardly. The reinforce portion (16) formed behind the chip guide surface (18) enhances the rigidity of the tool holder (1).

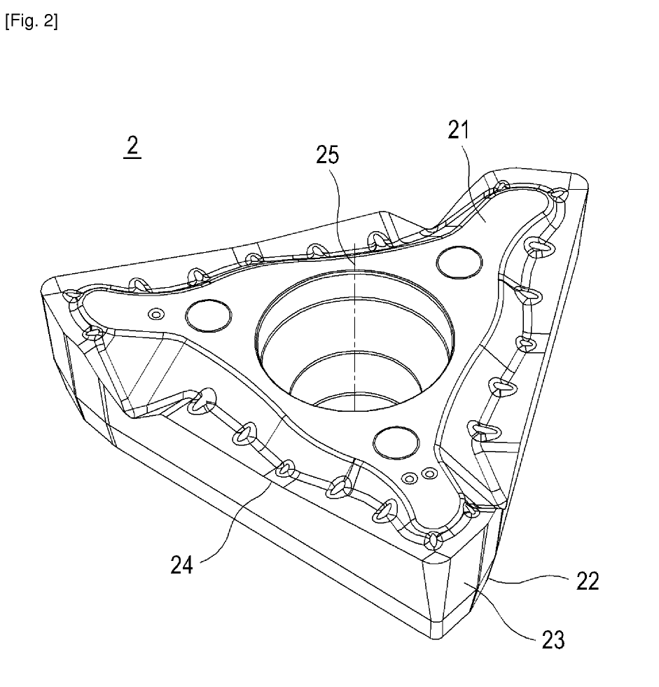

FIG. 2 shows a perspective view of a cutting insert (2) mounted in the cutting tool according to the present invention. The cutting insert (2) has a generally triangular shape with a top surface (21), a bottom surface (22) and lateral surfaces (23) extending therebetween. A mounting hole (25) is formed at the center of the top surface (21) and the bottom surface (22) while passing through the cutting insert (2). As shown in FIGS. 1 and 2, a screw (27) is inserted through the mounting hole (25) so that the cutting insert (2) is mounted on the bottom surface of the pocket (11). Cutting edges (24) are formed along the edges where the top surface (21) and the lateral surfaces (23) intersect.

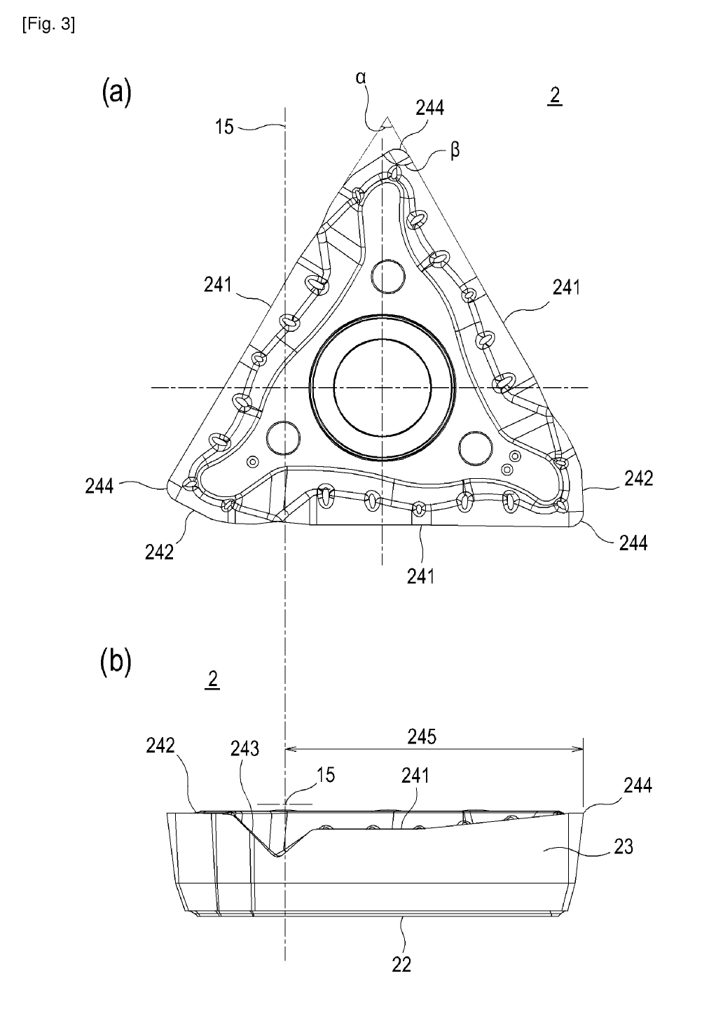

Referring to FIG. 3(a), a cutting edge (24) comprises a major cutting edge (241) and a minor cutting edge (242), which is shorter than the major cutting edge (241). Each side of the triangular-shaped cutting insert (2) comprises one major cutting edge (241) and one minor cutting edge (242) so that the cutting insert (2) is indexable in three directions. Ratio of the length of the major cutting edge (241) to the length of the minor cutting edge (242) is 3:1 to 7:1, preferably 4:1 to 5:1. A minor cutting edge (241) that is too short causes low rigidity of the minor cutting edge (241), while a minor cutting edge (241) that is too long causes an extremely large overall size of the cutting insert (2).

The two adjacent major cutting edges (241) form an angle (α) of 60° therebetween, the adjacent major and minor cutting edges (241, 242) that intersect at a corner (244) of the triangular shape forming an acute angle (β) of 80 to 89°, more preferably 85 to 89°, therebetween. Because the angle (β) is set to be acute below 90°, the cutting tool can perform both drilling and turning operations without any interference. An angle (β) that is too small causes low rigidity at the corner (244), vibrations and high roughness of the processed surface.

FIG. 3(b) shows the lateral surface (23) of the cutting insert (2). As the distance from the corner of the cutting insert (244) increases, the height of the major cutting edge (241) from the bottom surface (22) of the cutting insert (2) decreases until the lowest point beyond the center (15) of the tool holder (1). It then increases again as it approaches the minor cutting edge (242). As such, the major cutting edge (241) of the cutting edge (2) forms a positive rake angle over the entire portion (245) which is involved in the drilling operation, thereby advantageously reducing the cutting resistance. The portion (243) of the major cutting edge (241), wherein its height increases again, is formed to be slanted by 20 to 70°, preferably 45°, with respect to the bottom surface (22) of the cutting insert (2). Thus, the cutting chips generated during the drilling operation collide with the slant surface (243) as they pass over the major cutting edge (241), the curl size of the discharged chip is reduced, fluid of the chip is induced into the body of the cutting insert, and chip discharge performance improves. Further, since the chips become broken on the slant surface (243) and the generation of long chip is reduced thereby, damage to the workpiece and insert tip, chip tangle and vibration during an operation due to the long chips are prevented. The chips, which are broken or upwardly turned by the contact with the slant surface (243) of the cutting insert (2), are turned again on the chip guide surface (18) formed at the front end portion of the chip discharge groove (12) so that they are introduced into the chip discharge groove (12) (see FIG. 1). That is, the slant surface (243) and the chip guide surface (18) with a certain distance of gap (approximately the length of the minor cutting edge (242)) therebetween remarkably improve the chip discharge performance.

Further, since the chips generated during the cutting collide with the slant surface (243) in advance of colliding with the chip guide surface (18), the impact exerted to the chip guide surface (18) by the chips are reduced. As such, the damage and wear of the tool holder (1) are reduced. Thus, the lifetime of the tool holder (1) increases.

The width of the lateral surface (23) extending between the top surface (21) and the bottom surface (22) of the cutting insert (2) narrows as it approaches the bottom surface so that a positive clearance angle is formed. The positive clearance angle allows the cutting insert (2) to perform a cutting operation with less cutting resistance.

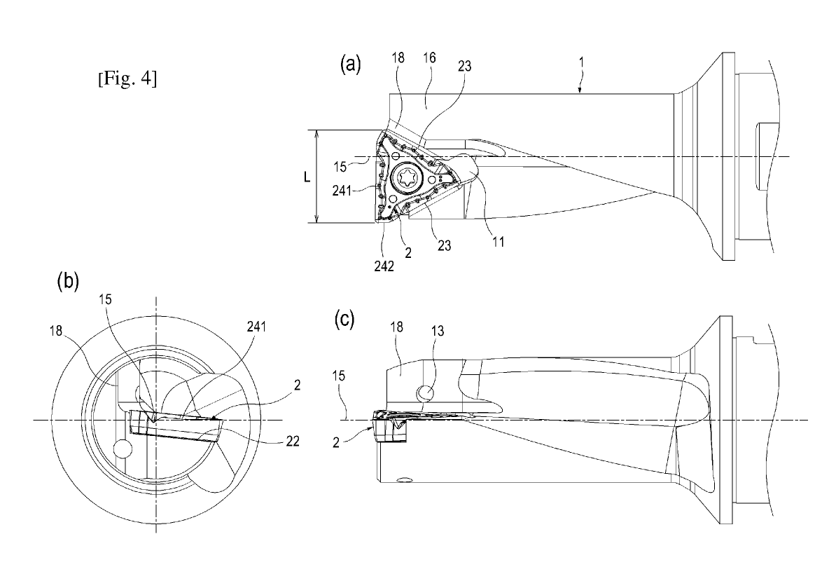

FIGS. 4(a) to 4(c) show the view of the cutting insert (2) mounted in the tool holder (1) from the top surface, lateral surface and front surface, respectively.

The cutting insert (2) is mounted in the pocket (11) of the tool holder (1) so that one of the major cutting edges (241) is projected in an axially forward direction of the tool holder (1) and the minor cutting edge (242) on the side adjacent to the projected major cutting edge is projected in a radially outward direction of the tool holder (1). Thus, the above projected major cutting edge (241) and minor cutting edge (242) of the cutting insert (2) can perform the drilling and turning operation. In U.S. Pat. No. 6,877,935 discussed above, the six cutting edges (71) are not classified into the major cutting edges or minor cutting edges. Thus, the cutting edges worn by the turning operations partly participate in the drilling operations. On the contrary, the cutting edges used in the drilling operations participate in the turning operations. Such a non-uniform wear of the cutting edges may cause a non-uniform processed surface. On the other hand, such a problem does not occur in the present invention because the major cutting edge (241) and the minor cutting edge (242) are formed separately.

The length (L) of one side of the cutting insert (2) is longer than the radius of the tool holder (1) but shorter than the diameter of the tool holder (1). The length (L) is about 0.65 to 0.85 times of the diameter. Preferably, the length (L) is 0.75 times of the diameter. A cutting insert (2) of the above size is formed in a generally triangular shape and disposed at one side of the front end of the tool holder (1). Thus, a sufficient material can be disposed on the reinforce portion (16) formed behind the chip guide surface (18) of another side of the front end. As such, rigidity of the tool holder (1) is increased so that twisting and vibrations of the tool holder are reduced.

The bottom surface (22) and two lateral surfaces (23) of the cutting insert (2) are tightly fixed to the bottom surface and two side walls of the pocket (11), respectively. The cutting insert is a generally equilateral triangular shape. The two side walls of the pocket form an angle of about 60° therebetween. Because the two side walls of the pocket (11) form an acute angle therebetween, the cutting insert can be securely fixed during machining. This provides the effects of preventing vibration during machining, improving machining quality and extending lifetime of the cutting insert.

In the meantime, the cutting edge can be damaged at the center of the drilling hole since the cutting speed is zero at that point. In order to avoid such a phenomenon, the major edge (241) is formed to have a height that is slightly less than the center (15) of the tool holder as shown in FIG. 4(b).

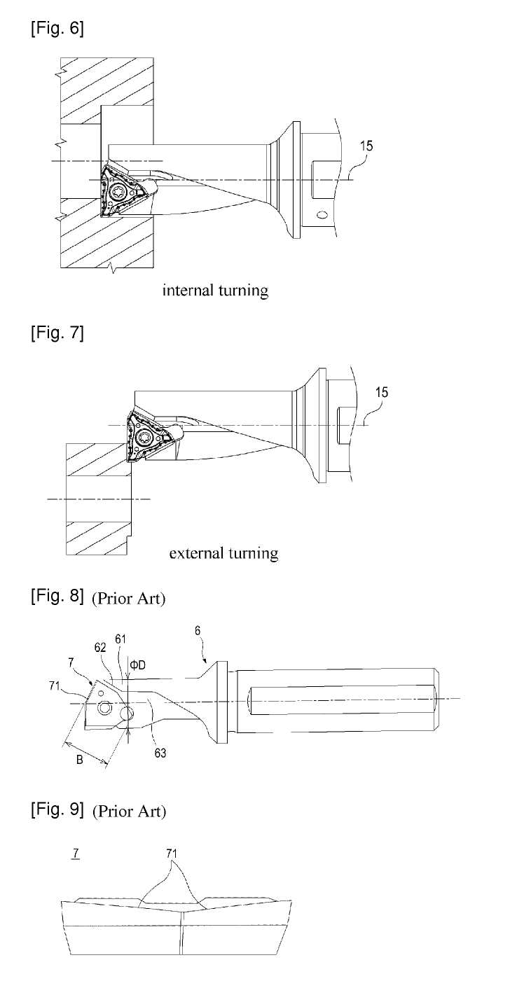

The operations, which can be performed by using the cutting tool of the present invention, will be described with reference to FIGS. 5 to 7. FIG. 5 depicts a drilling operation that is performed by using the cutting tool of the present invention. When the diameter of the hole is set to be identical to the diameter of the tool holder, the center (15) of the tool holder (1) is aligned with the center of the hole. Occasionally, the center (15) of the tool holder can be eccentrically biased from the center of hole so as to form the hole with a larger diameter of the tool holder. FIGS. 6 and 7 respectively depict an internal turning operation and an external turning operation performed while using the cutting tool of the present invention. As such, the present invention allows both drilling operation and internal/external turning operation to be performed by a single tool. This is because the major cutting edge (241) of the cutting insert (2) is projected in an axially forward direction of the tool holder (1), the minor cutting edge (242) on the side adjacent to the projected major cutting edge (241) is projected in a radially outward direction of the tool holder (1), and adjacent major cutting edges (241) and minor cutting edges (242) that intersect at a corner (244) of the triangular shape form an acute angle below 90° therebetween.

In the above, although the cutting insert and the cutting tool of the present invention are described in detail with reference to the figures, it is an explanation based on one embodiment of the present invention in order to facilitate the understanding of the present invention, and it is not intended to limit the scope of the present invention. Modifications, alternatives and adjustments that are obvious to a person of ordinary skill in the art can be made within the technical scope of the present invention.

1. A cutting tool for drilling and turning, comprising;
a generally triangular cutting insert; and
a tool holder having a pocket configured to receive said cutting insert and a chip discharge groove facilitating a discharge of chips,
wherein said cutting insert forms, on each side thereof, a major cutting edge and a minor cutting edge shorter than said major cutting edge, two adjacent major cutting edges forming an angle of 60° therebetween adjacent major and minor cutting edges intersecting at a corner of the triangular shape forming an angle of 80 to 89° therebetween; and
wherein said cutting insert is mounted in said pocket so that one of the major cutting edges is projected in an axially forward direction of the tool holder while the minor cutting edge on the side adjacent to said projected major cutting edge is projected in a radially outward direction.

2. The cutting tool of claim 1, wherein a length of one side of said cutting insert is 0.65 to 0.85 times of a diameter of the tool holder.

3. The cutting tool of claim 1, further comprising a chip guide surface upwardly extending to an outer peripheral surface of the tool holder so that the cutting chips generated from said major cutting edge are guided backwardly from the front end of the chip discharge groove.

4. The cutting tool of claim 1, wherein as a distance from the corner of the cutting insert increases, a height of said major cutting edge from the bottom surface of the cutting insert decreases until the lowest point beyond the center of the tool holder, and wherein said height increases again as it approaches the minor cutting edge.

5. The cutting tool of claim 4, wherein the portion of said major cutting edge, in which the height of the major cutting edge increases again, is slanted by an angle of 20 to 70° with respect to the bottom surface of the cutting insert.

6. The cutting tool of claim 2, wherein as a distance from the corner of the cutting insert increases, a height of said major cutting edge from the bottom surface of the cutting insert decreases until the lowest point beyond the center of the tool holder, and wherein said height increases again as it approaches the minor cutting edge.

7. The cutting tool of claim 3, wherein as a distance from the corner of the cutting insert increases, a height of said major cutting edge from the bottom surface of the cutting insert decreases until the lowest point beyond the center of the tool holder, and wherein said height increases again as it approaches the minor cutting edge.

8. A three-way indexable drilling and turning cutting insert, comprising:
a generally triangular shape having a top surface, a bottom surface, and three insert sides extending between the top surface and the bottom surface, each insert side extending between adjacent insert corners;
each insert side having a major cutting edge connected to a minor cutting edge which is shorter than the major cutting edge;
major cutting edges of adjacent insert sides forming an angle of 60° therebetween;
adjacent major and minor cutting edges belonging to different sides intersecting at a corner of the triangular shape and forming an angle of 80 to 89° therebetween;
in a side view of the cutting insert, the major cutting edge has a first portion which slopes downwardly in a direction towards the bottom surface from one corner until reaching a lowest point beyond one-half the length of the side, and a second portion which slopes upwardly from the lowest point in a direction away from the bottom surface at an angle of 20 to 70° with respect to the bottom surface to meet the minor cutting edge.

9. A cutting tool for drilling and turning, comprising;
a tool holder having a pocket configured to receive a cutting insert and a chip discharge groove facilitating a discharge of chips, and
a three-way indexable drilling and turning cutting insert mounted in the pocket, the cutting insert comprising:
a generally triangular shape having a top surface, a bottom surface, and three insert sides extending between the top surface and the bottom surface, each insert side extending between adjacent insert corners;
each insert side having a major cutting edge connected to a minor cutting edge which is shorter than the major cutting edge;
major cutting edges of adjacent insert sides forming an angle of 60° therebetween;
adjacent major and minor cutting edges belonging to different sides intersecting at a corner of the triangular shape and forming an angle of 80 to 89° therebetween;
in a side view of the cutting insert, the major cutting edge has a first portion which slopes downwardly in a direction towards the bottom surface from one corner until reaching a lowest point beyond one-half the length of the side, and a second portion which slopes upwardly from the lowest point in a direction away from the bottom surface at an angle of 20 to 70° with respect to the bottom surface to meet the minor cutting edge, wherein:
the cutting insert is mounted in the pocket so that one of the major cutting edges is projected in an axially forward direction of the tool holder while the minor cutting edge on the side adjacent to said projected major cutting edge is projected in a radially outward direction.

10. The cutting tool of claim 9, wherein a length of one side of said cutting insert is 0.65 to 0.85 times of a diameter of the tool holder.

11. The cutting tool of claim 9, further comprising a chip guide surface upwardly extending to an outer peripheral surface of the tool holder so that the cutting chips generated from said major cutting edge are guided backwardly from the front end of the chip discharge groove.
